(19) United States
(12) Patent Application Publication
(10) Pub. No.: US 2025/0292712 A1
(43) Pub. Date: Sep. 18, 2025

(54) DISPLAY APPARATUS AND ELECTRONIC DEVICE

(71) Applicant: WUHAN CHINA STAR OPTOELECTRONICS TECHNOLOGY CO., LTD., Wuhan (CN)

(72) Inventor: Huanli YANG, Wuhan (CN)

(73) Assignee: WUHAN CHINA STAR OPTOELECTRONICS TECHNOLOGY CO., LTD., Wuhan (CN)

(21) Appl. No.: 18/674,772

(22) Filed: May 24, 2024

Related U.S. Application Data
(63) Continuation of application No. PCT/CN2024/086451, filed on Apr. 7, 2024.

(30) Foreign Application Priority Data
Mar. 15, 2024 (CN) 202410302505.7

(51) Int. Cl. G09G 3/00; G06F 3/14

(52) U.S. Cl. CPC G09G 3/035; G06F 3/1423

(57) ABSTRACT

A display apparatus includes one or more display screens and one or more optical elements corresponding to the one or more display screens respectively. For each optical element and its corresponding display screen, the optical element is disposed at a light exit side of the display screen, the optical element includes a first lens at a side away from the display screen, the first lens includes a first curved surface away from the display screen, and the first curved surface is a concave surface facing toward the display screen.

### CROSS-REFERENCE TO RELATED APPLICATIONS

The present application is a continuation of International Application No. PCT/CN2024/086451, filed on Apr. 7, 2024, which claims priority to Chinese Patent Application No. 202410302505.7, filed on Mar. 15, 2024. The disclosures of the abovementioned applications are incorporated herein by reference in their entireties.

### TECHNICAL FIELD

The present application relates to display technologies, and in particular to a display apparatus and an electronic device.

### BACKGROUND

With the increasing demand on consumer electronic products, virtual reality display technologies or augmented reality display technologies have attracted more and more attention. Offering a relatively good immersive experience, the virtual reality is increasingly favored by consumers. The core objective of virtual reality is to provide immersive illusion, and the key to achieving immersive illusion is the panorama. FOV (Filed of View) represents an angle from which the panorama can be seen, and is an iconic parameter that embodies a core optical technology.

The diameter of the lens is usually increased for a larger FOV. However, the increased diameter means an increased weight and increased volume of the product.

### SUMMARY

One or more embodiments of the present application provide a display apparatus, and the display apparatus includes one or more display screens and one or more optical elements corresponding to the one or more display screens respectively. For each optical element and its corresponding display screen, the optical element is disposed at a light exit side of the display screen, the optical element includes a first lens at a side away from the display screen, the first lens includes a first curved surface away from the display screen, and the first curved surface is a concave surface facing toward the display screen.

One or more embodiments of the present application provide an electronic device, and the electronic device includes a frame and a display apparatus; the display apparatus includes one or more display screens and one or more optical elements corresponding to the one or more display screens respectively. For each optical element and its corresponding display screen, the optical element is disposed at a light exit side of the display screen, the optical element includes a first lens at a side away from the display screen, the first lens includes a first curved surface away from the display screen, and the first curved surface is a concave surface facing toward the display screen.

### BRIEF DESCRIPTION OF THE DRAWINGS

The technical solutions and beneficial effects of the present application will be described in detail in specific embodiments of the present application in combination with the accompanying drawings.

FIG. 1 is a schematic structural diagram of a display module provided in the related art;

FIG. 2 is a schematic structural diagram of a display apparatus according to one or more embodiments of the present application;

FIGS. 3 and 4 are schematic structural diagrams of a display module according to one or more embodiments of the present application;

FIG. 5A is a schematic structural diagram of another display module according to one or more embodiments of the present application;

FIG. 5B is a schematic structural diagram of another display module according to one or more embodiments of the present application;

FIG. 5C is a schematic structural diagram of another display module according to one or more embodiments of the present application;

FIG. 6 is a schematic structural diagram of another display module according to one or more embodiments of the present application;

FIG. 7 is a schematic structural diagram of another display module according to one or more embodiments of the present application;

FIG. 8A is a schematic structural diagram of another display module according to one or more embodiments of the present application;

FIG. 8B is a schematic structural diagram of another display module according to one or more embodiments of the present application;

FIG. 9 is a schematic structural diagram of another display module according to one or more embodiments of the present application;

FIG. 10 is a schematic diagram showing simulation of multiple fields of view of a display module according to one or more embodiments of the present application;

FIGS. 11 to 13 are schematic diagrams of aberrations in a first comparative example according to one or more embodiments of the present application;

FIGS. 14 to 16 are schematic diagrams of aberrations in a second comparative example according to one or more embodiments of the present application;

FIGS. 17 to 19 are schematic diagrams of aberrations in an implemented example according to one or more embodiments of the present application;

FIG. 20 is a schematic structural diagram showing a display screen and an optical element according to one or more embodiments of the present application;

FIGS. 21 to 23 are schematic diagrams of distribution of fields of view according to one or more embodiments of the present application; and

FIG. 24 is a schematic structural diagram of an electronic device according to one or more embodiments of the present application.

### DETAILED DESCRIPTION

Some embodiments of the present application will be described in detail below with reference to the accompanying drawings. The embodiments are described for illustrative purposes only and are not intended to limit the present application.

Different embodiments or examples are provided below for implementing various structures in the embodiments of the present application. To simplify the disclosure of the present application, components and arrangements in specific examples are described below. Of course, they are merely examples and are not intended to limit the present application. Besides, reference numbers and/or reference letters may be repeated in different examples of the present application, and such repetition is for the purposes of simplicity and clarity and does not by itself indicate a relationship between the various embodiments and/or arrangements disclosed. In addition, examples of various specific processes and materials are provided in the present application, and one of ordinary skill in the art can recognize the application of other processes and/or the use of other materials.

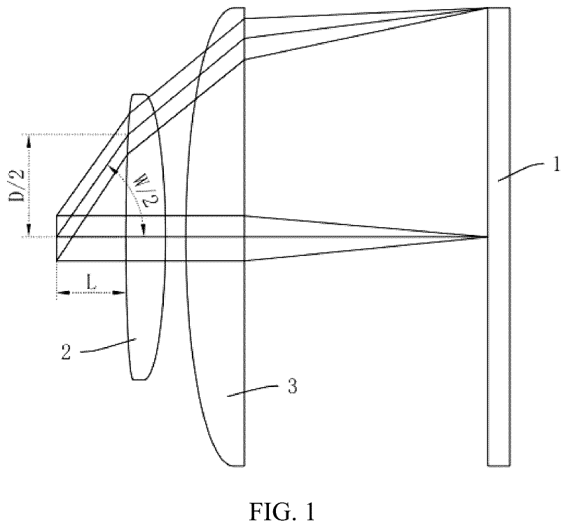

Referring to FIG. 1, a virtual reality display module provided in the related art includes: a display 1, a first lens 2 located on a light exit side of the display 1, and a second lens 3 located between the display 1 and the first lens 2. The FOV of the display module may be increased by increasing the diameter D of the first lens 2 according to a calculation formula related to the lens diameter, D=2L×Tan(W/2), where L represents the fixed focal length, and Tan(W/2) represents the half FOV. It can be seen that the lens diameter D will increase rapidly as the FOV increases.

For example, in a case where W=120°, D=2L×Tan 60°=2L×1.732; and in a case where W=140°, D=2L×Tan 70°=2L×2.747.

When the half field of view (W/2) increases from 60° to 70°, the lens diameter D increases to 1.59 times the original lens diameter. In a case where L=15 mm, and W=140°, the lens diameter D=30 ×Tan 70°=82.4 mm, and the value will be larger in real world. Therefore, the first lens 2 with a too large size will be resulted, which results in the display module being of a too large size, and not conducive to the use and portability of the product, and is far beyond the normal adjustable range for interpupillary distance.

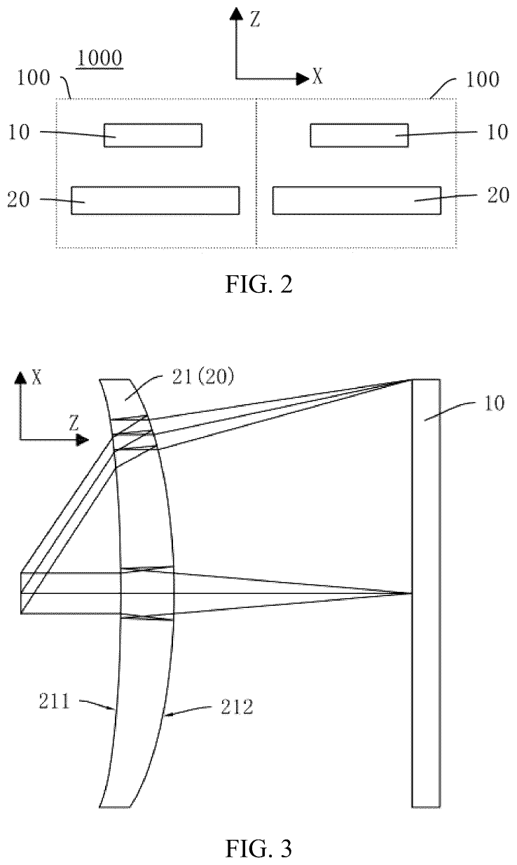

Referring to FIGS. 2 and 3, a display apparatus 1000 is provided in one or more embodiments of the present application. The display apparatus 1000 includes a display screen 10 and an optical element 20. The optical element 20 is disposed at a light exit side of the display screen 10, and the optical element 20 includes a first lens 21 at a side away from the screen 10. The first lens includes a first curved surface 211 away from the display screen 10, and the first curved surface 211 is a concave surface facing toward the display screen 10.

During the implementation of the embodiment(s) of the present application, the first curved surface 211 of the first lens 21 in the optical element 20 at the side away from the display screen 10 is arranged to be the concave curved surface, and the first curved surface 211 is located at the side of the first lens 21 away from the display screen 10 (that is, the first curved surface 211 is located on a side close to the human eyes). Since the first curved surface 211 protrudes outward away from the human eyes, the dimensions of the first lens 21 in the directions parallel to the display screen 10 may be reduced, and the dimensions of the display apparatus 1000 may be reduced. As a result, the convenience of use of the display apparatus 1000 is improved, and the adjustment function of the display apparatus 1000 for interpupillary distance is further facilitated.

In an embodiment of the present application, the first lens further includes a second curved surface close to the display screen, and the second curved surface protrudes toward the display screen; the first curved surface is a cylindrical surface or a free-form surface, and the second curved surface is a cylindrical surface or a free-form surface.

In an embodiment of the present application, the first curved surface is a cylindrical surface, and the optical element further includes: a first reflective polarizer, a first quarter-wave plate, and a first semi-transmissive and semi-reflective film; the first quarter-wave plate is disposed on the first curved surface, and the first reflective polarizer is disposed on a side of the first quarter-wave plate away from the first curved surface, and the first semi-transmissive and semi-reflective film is located between the first quarter-wave plate and the display screen.

In an embodiment of the present application, the second curved surface is a free-form surface, and the first semi-transmissive and semi-reflective film is disposed on the second curved surface.

In an embodiment of the present application, the optical element further includes a second lens disposed between the first lens and the display screen, the second lens includes a third curved surface away from the display screen and a fourth curved surface close to the display screen, the second curved surface, the third curved surface and the fourth curved surface each are a free-form surface; the optical element further includes a first anti-reflection film and a second anti-reflection film, and the first semi-transmissive and semi-reflective film is disposed on one of the second curved surface, the third curved surface and the fourth curved surface, and the first anti-reflection film and the second anti-reflection film are disposed on the other two of the second curved surface, the third curved surface and the fourth curved surface, respectively.

In an embodiment of the present application, the first curved surface is a free-form surface, and the second curved surface is a free-form surface; the optical element further includes a third anti-reflection film disposed on the first curved surface, and a fourth anti-reflection film disposed on the second curved surface.

In an embodiment of the present application, the optical element further includes a second lens disposed between the first lens and the display screen, the second lens includes a third curved surface away from the display screen and a fourth curved surface close to the display screen, and the first curved surface and the fourth curved surface each are a free-form surface.

In an embodiment of the present application, the second curved surface is a cylindrical surface, and the third curved surface is a free-form surface; the optical element further includes: a second semi-transmissive and semi-reflective film, a fifth anti-reflective film, a sixth anti-reflective film, a second reflective polarizer disposed on the second curved surface, and a second quarter-wave plate disposed on a side of the second reflective polarizer away from the second curved surface, the fifth anti-reflection film is disposed on the first curved surface, the second semi-transmissive and semi-reflective film is disposed on one of the third curved surface and the fourth curved surface, and the sixth anti-reflection film is disposed on the other of the third curved surface and the fourth curved surface.

In an embodiment of the present application, the third curved surface is a cylindrical surface, and the second curved surface is a free-form surface; the optical element further includes: a third quarter-wave plate disposed on the third curved surface, a third reflective polarizer disposed on a side of the third quarter-wave plate away from the third curved surface, a third semi-transmissive and semi-reflective film disposed on the four-curved surface, a seventh anti-reflective film disposed on the first curved surface, and an eighth anti-reflective film disposed on the second curved surface.

In an embodiment of the present application, the display apparatus includes two display modules that are arranged side by side along a first direction, and each of the display modules includes one said optical element and its corresponding display screen; the cylindrical surface in each of the optical elements is curved in the first direction.

In an embodiment of the present application, at least one of the first curved surface and the second curved surface is a cylindrical surface with a curvature radius greater than or equal to 100 mm, and less than or equal to 2000 mm.

In an embodiment of the present application, the display apparatus includes two display modules that are arranged side by side along a first direction, and each of the display modules includes one said optical element and its corresponding display screen; in each of the display modules: a main optical axis of the optical element passes through the display screen and is located at a side of a geometric center of the display screen close to the other of the display modules; and the optical element includes a first profile edge and a second profile edge that are oppositely arranged along the first direction, and the second profile edge is located between the first profile edge and the other of the display modules. From a viewing angle perpendicular to the display screen, a minimum distance from the first profile edge to the main optical axis is greater than a minimum distance from the second profile edge to the main optical axis.

In an embodiment of the present application, in each of the display modules, the display screen includes a third profile edge and a fourth profile edge that are oppositely arranged along the first direction, the fourth profile edge is located between the third profile edge and the other of the display modules. From the viewing angle perpendicular to the display screen, a minimum distance from the third profile edge to the main optical axis is greater than a minimum distance from the fourth profile edge to the main optical axis.

In an embodiment of the present application, each of the display modules further includes a first side and a second side that are oppositely arranged along a second direction, the second direction being perpendicular to the first direction and parallel to the display screen of the display module. In each of the display modules, a minimum distance from a portion of the second profile edge close to the first side to the main optical axis is greater than a minimum distance from a portion of the second profile edge close to the second side to the main optical axis; and a minimum distance from a portion of the fourth profile edge close to the first side to the main optical axis is greater than a minimum distance from a portion of the fourth profile edge close to the second side to the main optical axis.

In an embodiment of the present application, in each of the display modules, the display screen has a virtual intersection point intersecting the main optical axis, and a line connecting the virtual intersection point and the geometric center of the display screen is parallel to the first direction.

In an embodiment of the present application, the display screen is located in the optical element from a viewing angle perpendicular to the display screen.

Referring to FIGS. 2 to 4, the display apparatus 1000 provided in the embodiments of the present application includes at least one display module 100. The display module 100 includes a display screen 10 and an optical element 20 located on a light exit side of the display screen 10. Light of images displayed on the display screen 10 is refracted or reflected by the optical element 20 such that an enlarged image is generated at a distance and then is seen by human eyes. The enlarged image is seen by human eyes to achieve immersive vision.

In an embodiment, as shown in FIG. 2, the display apparatus 1000 includes two display modules 100 arranged side by side along a first direction X. In the two display modules 100 that are arranged side by side, two display screens 10 are arranged side by side along the first direction X, and two optical elements 20 are arranged side by side along the first direction X. It will be understood that, the display apparatus 1000 provided in the embodiments of the present application may be used in the virtual reality display device, and the two display modules 100 that are arranged side by side may correspond to two eyes of the user, so that the images displayed by the display modules 100 are seen by the human eyes.

It will be noted that, the structure of one of the display modules 100 is taken as an example for explanation in the embodiments of the present application, and the two display modules 100 have the same structure and are arranged symmetrically.

In other embodiments of the present application, the number of the display module(s) 100 of the display apparatus 1000 may also be one or more than two, which is not limited herein.

In embodiments of the present application, the optical element 20 may include one or more lenses, and the lens may be an optical lens to adjust the optical path of the light emitted from the display screen 10 such that the light can be better received by human eyes.

As shown in FIG. 2, two display modules 100 in the display apparatus 1000 are arranged side by side along the first direction X. In addition, a second direction is set to be perpendicular to the first direction X and parallel to the display screen 10, and a third direction Z is set to be a direction of the optical element 20 approaching the display screen 10.

As shown in FIG. 3, the optical element 20 includes a first lens 21, and the first lens 21 is a lens of the optical element 20 that is farthest from the display screen 10. During the use of the display apparatus 1000, the first lens 21 is the lens of the optical element 20 that is closest to the human eyes. The first lens 21 includes a first curved surface 211 away from the display screen 10, and the first curved surface 211 is a concave surface facing toward the display screen 10. That is, the first curved surface 211 protrudes outward away from the human eyes. Therefore, it may reduce the dimensions of the first lens 21 in the directions parallel to the display screen 10, and reduce the dimensions of the display apparatus 1000. As a result, the convenience of use of the display apparatus 1000 is improved, and the adjustment function of the display apparatus 1000 for interpupillary distance is further facilitated.

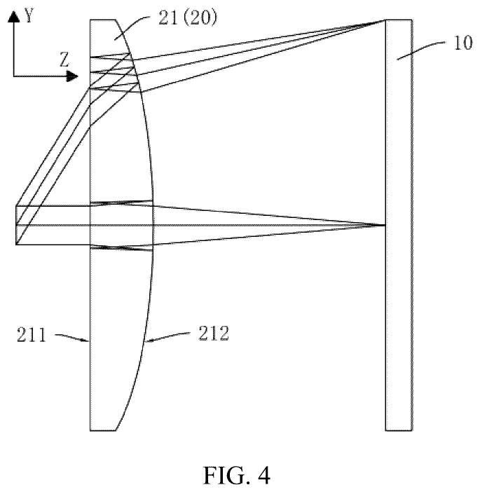

In an embodiment, as shown in FIGS. 3 and 4, the first lens 21 further includes a second curved surface 212 close to the display screen 10, and the second curved surface 212 protrudes toward the display screen 10.

In addition, the first curved surface 211 may be a cylindrical surface or a free-form surface, and the second curved surface 212 may be a cylindrical surface or a free-form surface. It will be noted that, the design of the first curved surface 211 may reduce the dimension of the first lens 21 in the first direction X or the dimension of the first lens 21 in the second direction Y. Since the first curved surface 211 is the cylindrical surface or the free-form surface, due to the non-rotational symmetry of the optical system of the first surface 211, there are unconventional aberrations which are difficult to be corrected by conventional rotationally symmetric surfaces, and thus the center of the aberration field will deviate from the center of the Gaussian image plane of the optical system, and the offset amount and the offset direction are also different in different fields of view, which will lead to poor imaging effect of the display module 100 and seriously affect the display quality. Therefore, in the embodiments of the present application, the second curved surface 212 is also a non-rotationally symmetric curved surface to correct the aberrations caused by the first curved surface 211, thereby improving the imaging quality of the display module 100.

In an embodiment, one of the first curved surface 211 and the second curved surface 212 is a cylindrical surface, and the other of the first curved surface 211 and the second curved surface 212 is a free-form surface.

In an embodiment, the cylindrical surface is curved in the first direction X. The horizontal limit FOV (the limit field of view along the first direction X) of the human eye is 155° (FOV of 90° at the temporal side>FOV of 65° at the nasal side), and the vertical limit FOV (the limit field of view along the second direction Y) of the human eye is 130° (FOV of 70° at the lower side>FOV of 60° at the upper side). That is, the FOV of the human eye is larger in the first direction X. Therefore, the first lens 21 requires a larger diameter in the first direction X. In the embodiments of the present application, the cylindrical surface is curved in the first direction X, that is, the extension direction of the straight generatrix of the cylindrical surface is perpendicular to the first direction X, so that the diameter of the first lens 21 in the first direction X may be increased to a certain extent. As a result, the display quality and immersion of the display device 1000 is improved.

In other embodiments of the present application, the cylindrical surface may also be curved in the second direction Y.

In an embodiment, a curvature radius of the cylindrical surface is greater than or equal to 100 mm, and less than or equal to 2000 mm. When the curvature radius of the cylindrical surface is too small, the attachment of the optical film on the cylindrical surface will be seriously affected. When the curvature radius of the cylindrical surface is too large, the reduction in the dimensions of the first lens 21 is too small.

In an embodiment, the free-form surface may include a biconical surface, an xy polynomial surface, a toric base xy-polynomial surface, or other free-form surface.

In an embodiment of the present application, referring to FIGS. 2 to 4, the display module 100 adopts an ultra-short focus optical folding path (Pancake) to further improve the thinness and light-weight of the display apparatus 1000.

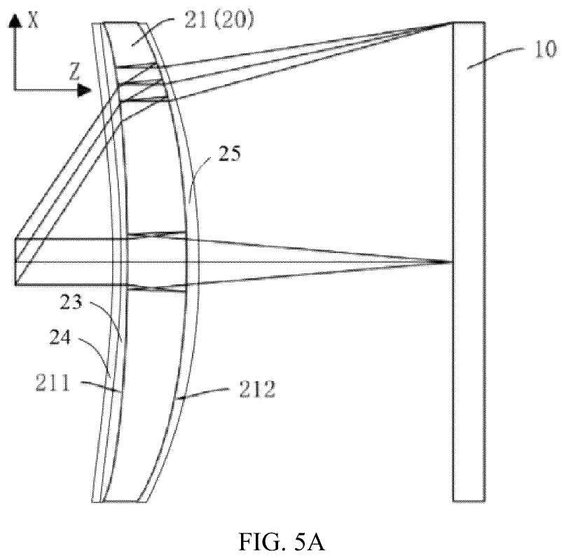

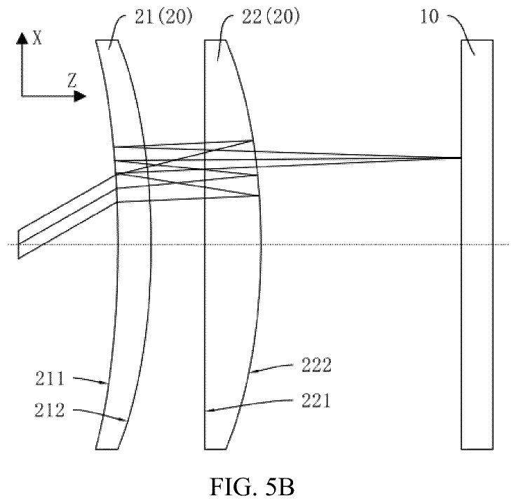

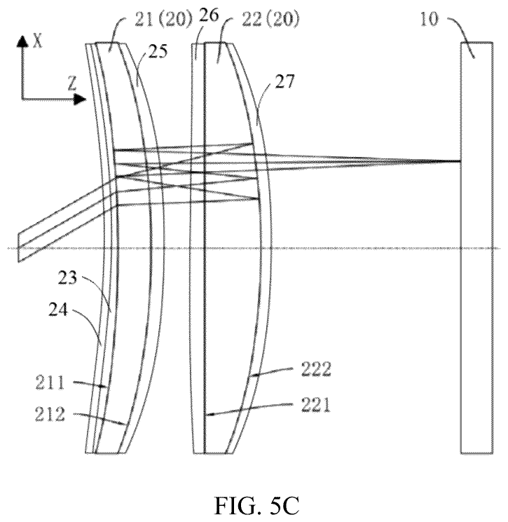

As shown in FIG. 5A, the first curved surface 211 is the cylindrical surface, and the second curved surface 212 is the free-form surface. The optical element 20 further includes: a first quarter-wave plate 23, a first reflective polarizer 24, and a first semi-transmissive and semi-reflective film 25.

The first quarter-wave plate 23 is disposed on the first curved surface 211, the first reflective polarizer 24 is disposed on a side of the first quarter-wave plate 23 away from the first curved surface 211, and the first semi-transmissive and semi-reflective film 25 is disposed between the first quarter-wave plate 23 and the display screen 10. For example, the first semi-transmissive and semi-reflective film 25 may be disposed on the second curved surface 212.

It will be noted that, the first quarter-wave plate and the first reflective polarizer are attached on the first curved surface 211, and thus the optical performance of the first quarter-wave plate and the first reflective polarizer may be affected due to deformation during the attachment processes. Therefore, in the embodiments of the present application, the first curved surface 211 is chosen to be the cylindrical surface, and the cylindrical surface is only curved in one direction, which may reduce the deformation caused by the attachment of the first quarter-wave plate and the first reflective polarizer, and thereby reduce the impact on the optical performance due to the deformation of the first quarter-wave plate and the first reflective polarizer. As a result, the imaging quality of the display module 100 is improved. The first semi-transmissive and semi-reflective film may be formed on the second curved surface 212 by evaporation, and thus will not be affected by the shape of the second curved surface 212.

It will be understood that, due to the first reflective polarizer and the first quarter-wave plate of the display module 100, the light emitted from the display screen 10 is refracted multiple times in the optical element 20 and then enter the human eye, which facilitates the diopter adjustment of display apparatus 1000.

In some other embodiments of the present application, referring to FIGS. 2, 5B and 5C, the optical element 20 further includes a second lens 22 disposed between the first lens 21 and the display screen 10, and the second lens 22 includes a third curved surface 221 away from the display screen 10 and a fourth curved surface 222 close to the display screen 10.

The first curved surface 211 is a cylindrical surface, and the second curved surface 212, the third curved surface 221 and the fourth curved surface 222 each are a free-form surface.

The optical element 20 further includes: the first quarter-wave plate 23, the first reflective polarizer 24, the first semi-transmissive and semi-reflective film 25, a first anti-reflection film 26 and a second anti-reflection film 27. The first quarter-wave plate 23 is disposed on the first curved surface 211, the first reflective polarizer 24 is disposed on a side of the first quarter-wave plate 23 away from the first curved surface 211, the first semi-transmissive and semi-reflective film 25 is disposed on one of the second curved surface 212, the third curved surface 221 and the fourth curved surface 222, and the first anti-reflective film 26 and the second anti-reflective film 27 are disposed on the other two of the second curved surface 212, the third curved surface 221 and the fourth curved surface 222, respectively.

For example, as shown in FIG. 5C, in a case where the first semi-transmissive and semi-reflective film 25 is disposed on the second curved surface 212, the first anti-reflective film 26 and the second anti-reflective film 27 are disposed on the third curved surface 221 and the fourth curved surface 222, respectively. Alternatively, in a case where the first semi-transmissive and semi-reflective film 25 is disposed on the third curved surface 221, the first anti-reflective film 26 and the second anti-reflective film 27 are disposed on the second curved surface 212 and the fourth curved surface 222, respectively. Alternatively, in a case where the first semi-transmissive and semi-reflective film 25 is disposed on the fourth curved surface 222, the first anti-reflection film 26 and the second anti-reflection film 27 are disposed on the second curved surface 212 and the third curved surface 221, respectively.

It will be noted that, the first quarter-wave plate and the first reflective polarizer are attached on the first curved surface 211, and thus the optical performance of the first quarter-wave plate and the first reflective polarizer may be affected due to the deformation during the attachment processes. Therefore, in the embodiments of the present application, the first curved surface 211 is chosen to be the cylindrical surface, and the cylindrical surface is only curved in one direction, which may reduce the deformation caused by the attachment of the first quarter-wave plate and the first reflective polarizer, and thereby reduce the impact on the optical performance due to the deformation of the first quarter-wave plate and the first reflective polarizer. As a result, the imaging quality of the display module 100 is improved. The first semi-transmissive and semi-reflective film, the first anti-reflective film and the second anti-reflective film may be formed on the second curved surface 212, the third curved surface 221 and the fourth curved surface 222 by evaporation, respectively, and thus will not be affected by the shapes of the second curved surface 212, the third curved surface 221 and the fourth curved surface 222.

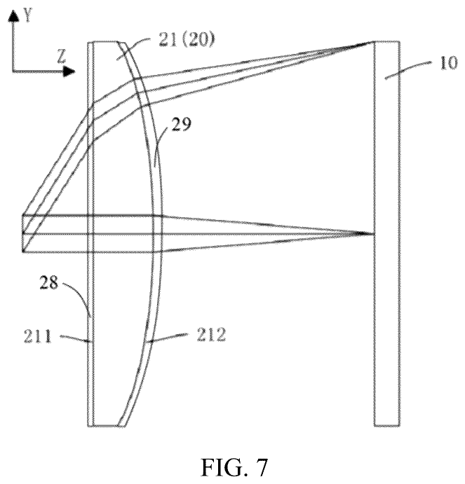

In an embodiment of the present application, referring to FIGS. 2, 6 and 7, the first curved surface 211 is a free-form surface, the second curved surface 212 is a free-form surface, and the optical element 20 further includes a third anti-reflection film 28 disposed on the first curved surface 211 and a fourth anti-reflection film 29 disposed on the second curved surface 212.

Alternatively, the first curved surface 211 is a cylindrical surface, the second curved surface 212 is a free-form surface, and the optical element 20 further includes a third anti-reflection film 28 disposed on the first curved surface 211 and a fourth anti-reflection film 29 disposed on the second curved surface 212.

Alternatively, the first curved surface 211 is a free-form surface, and the second curved surface 212 is an orthogonal cylindrical surface, and the optical element 20 further includes a third anti-reflection film 28 disposed on the first curved surface 211 and a fourth anti-reflection film 29 disposed on the second curved surface 212.

It will be noted that, each of the third anti-reflection film 28 and the fourth anti-reflection film 29 may be prepared on a surface (the first curved surface 211 or the second curved surface 212) of the optical element 20 by evaporation, and thus will not be affected by the shapes of the first curved surface 211 and the second curved surface 212.

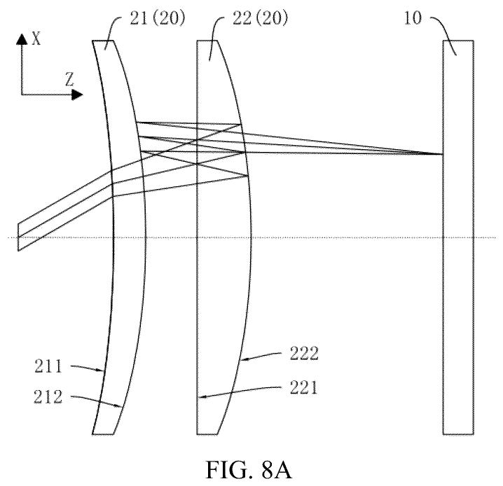

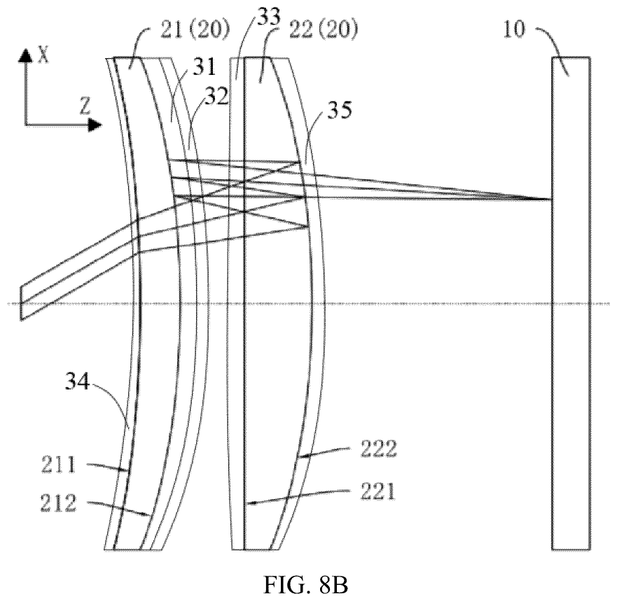

In another embodiment of the present application, referring to FIGS. 2 and 8A, the optical element 20 further includes a second lens 22 disposed between the first lens 21 and the display screen 10, and the second lens 22 includes a third curved surface 221 away from the display screen 10 and a fourth curved surface 222 close to the display screen 10.

The second curved surface 212 is a cylindrical surface, and the first curved surface 211, the third curved surface 221 and the fourth curved surface 222 each are a free-form surface.

As shown in FIG. 8B, the optical element 20 further includes: a second reflective polarizer 31, a second quarter-wave plate 32, a second semi-transmissive and semi-reflective film 33, a fifth anti-reflective film 34 and a sixth anti-reflective film 35. The second reflective polarizer 31 is disposed on the second curved surface 212, the second quarter-wave plate 32 is disposed on a side of the second reflective polarizer 31 away from the second curved surface 212, the fifth anti-reflection film 34 is disposed on the first curved surface 211, the second semi-transmissive and semi-reflective film 33 is disposed on one of the third curved surface 221 and the fourth curved surface 222, and the sixth anti-reflection film 35 is disposed on the other one of the third curved surface 221 and the fourth curved surface 222.

For example, the second semi-transmissive and semi-reflective film 33 is disposed on the third curved surface 221, and the sixth anti-reflection film 35 is disposed on the fourth curved surface 222. Alternatively, the sixth anti-reflection film 35 is disposed on the third curved surface 221, and the second semi-transmissive and semi-reflective film 33 is disposed on the fourth curved surface 222.

It will be noted that, the second quarter-wave plate and the second reflective polarizer are attached on the second curved surface 212, and thus the optical performance of the second quarter-wave plate and the second reflective polarizer may be affected due to deformation during the attachment processes. Therefore, in the embodiments of the present application, the second curved surface 212 is chosen to be the cylindrical surface, and the cylindrical surface is only curved in one direction, which may reduce the deformation caused by the attachment of the second quarter-wave plate and the second reflective polarizer, and thereby reduce the impact on the optical performance due to the deformation of the second quarter-wave plate and the second reflective polarizer. As a result, the imaging quality of the display module 100 is improved. The second semi-transmissive and semi-reflective film, the fifth anti-reflective film and the sixth anti-reflective film may be formed on the first curved surface 211, the third curved surface 221 and the fourth curved surface 222 by evaporation, respectively, and thus will not be affected by the shapes of the curved surface 211, the third curved surface 221 and the fourth curved surface 222.

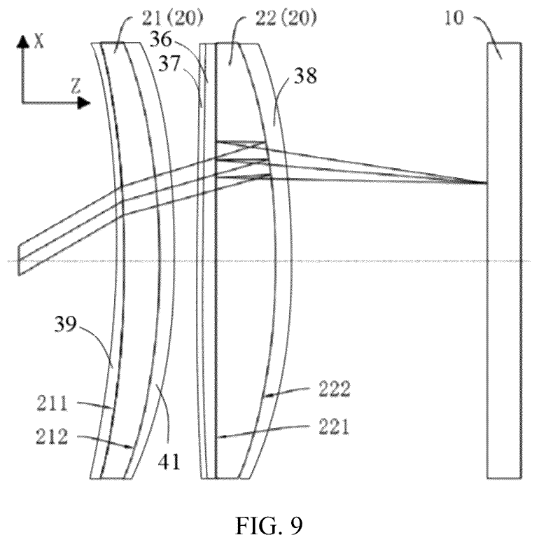

In some other embodiments of the present application, referring to FIGS. 2 and 9, the optical element 20 includes the second lens 22 disposed between the first lens 21 and the display screen 10, and the second lens 22 includes the third curved surface 221 away from the display screen 10 and the fourth curved surface 222 close to the display screen 10.

The third curved surface 221 is a cylindrical surface, and the first curved surface 211, the second curved surface 212 and the fourth curved surface 222 each are a free-form surface.

The optical element 20 further includes a third quarter-wave plate 36, a third reflective polarizer 37, a third semi-transmissive and semi-reflective film 38, a seventh anti-reflection film 39 and an eighth anti-reflection film 41. The third quarter-wave plate 36 is disposed on the third curved surface 221, the third reflective polarizer 37 is disposed on a side of the third quarter-wave plate 36 away from the third curved surface 221, the third semi-transmissive and semi-reflective film 38 is disposed on the fourth curved surface 222, the seventh anti-reflection film 39 is disposed on the first curved surface 211, and the eighth anti-reflection film 41 is disposed on the second curved surface 212.

It will be noted that, the third quarter-wave plate and the third reflective polarizer are attached on the third curved surface 221, and thus the optical performance of the third quarter-wave plate and the third reflective polarizer may be affected due to deformation during the attachment processes. Therefore, in the embodiments of the present application, the third curved surface 221 is chosen to be the cylindrical surface, and the cylindrical surface is only curved in one direction, which may reduce the deformation caused by the attachment of the third quarter-wave plate and the third reflective polarizer, and thereby reduce the impact on the optical performance due to the deformation of the third quarter-wave plate and the third reflective polarizer. As a result, the imaging quality of the display module 100 is improved. The third semi-transmissive and semi-reflective film, the seventh anti-reflective film and the eighth anti-reflective film may be formed on the first curved surface 211, the second curved surface 212 and the fourth curved surface 222 by evaporation, respectively, and thus will not be affected by the shapes of the first curved surface 211, the second curved surface 212 and the fourth curved surface 222.

In some other embodiments of the present application, lenses of the optical element 20 have multiple curved surfaces, and the multiple curved surfaces may include at least two cylindrical surfaces. Embodiments of the present application are not limited to the case where the optical element 20 includes only one cylindrical surface.

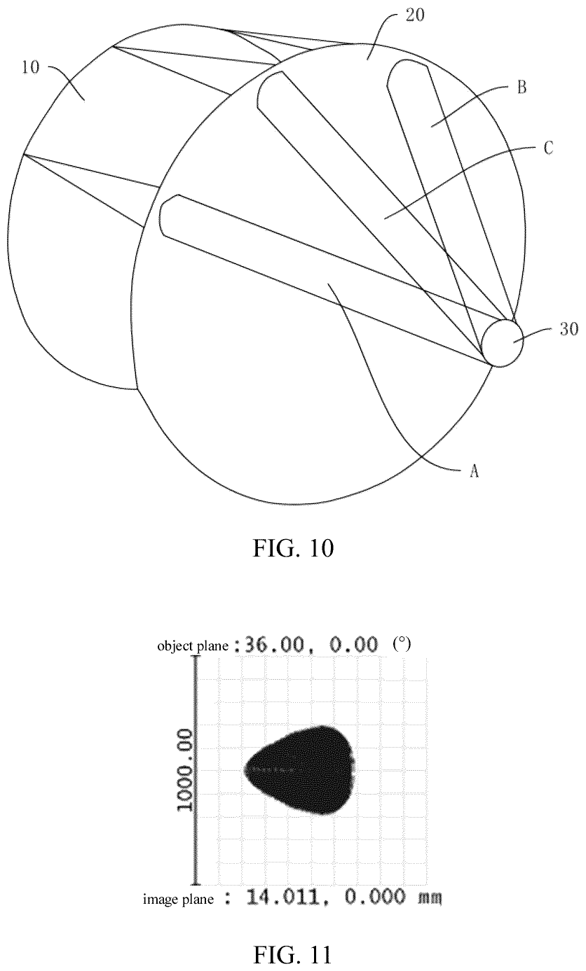

In addition, a first comparative example, a second comparative example and an implemented example are provided to verify the aberrations generated in display modules. In the first comparative example, the second comparative example and the implemented example, one lens is used for verification, and simulations of three fields of view shown in FIG. 10 are performed, the three fields of view including a tangential field of view A, a sagittal field of view B and other field of view C. As shown in FIG. 10, the line connecting the position of the tangential field of view A on the lens to the center of the lens is perpendicular to the line connecting the position of the sagittal field of view B on the lens to the center of the lens, and an included angle between the line connecting the position of the other field of view C on the lens to the center of the lens and the line connecting the position of the tangential field of view A on the lens to the center of the lens may be 45°.

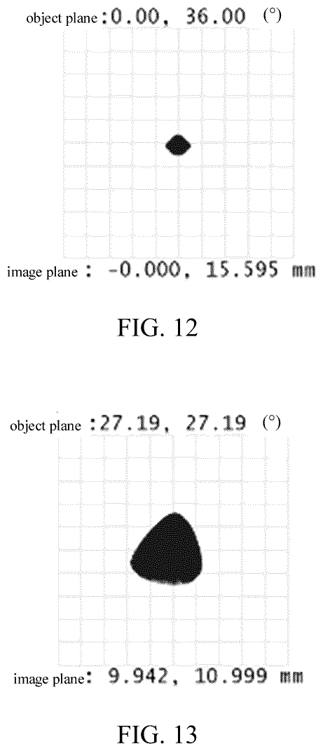

In the first comparative example, the surface of the lens away from the display screen 10 is a cylindrical surface, the surface of the lens close to the display screen 10 is a spherical surface, a quarter-wave plate and a reflective polarizer are attached on the cylindrical surface in a stacked manner, and a semi-transmissive and semi-reflective film is evaporated on the spherical surface. Results shown in FIGS. 11 to 13 are obtained after the simulation. FIG. 11 is a schematic diagram of the aberration in the tangential field of view in the first comparative example, FIG. 12 is a schematic diagram of the aberration in the sagittal field of view in the first comparative example, and FIG. 13 is a schematic diagram of the aberration in the other field of view in the first comparative example.

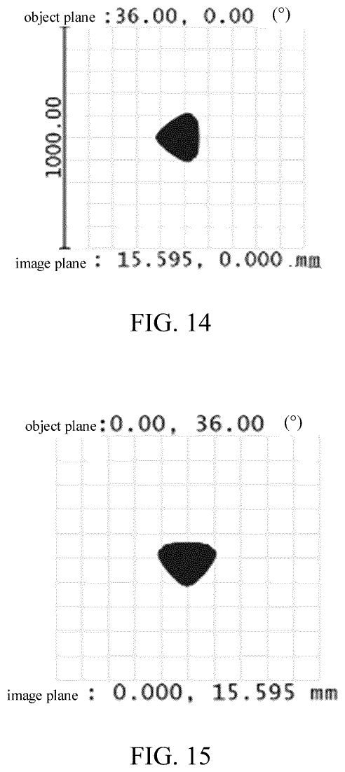

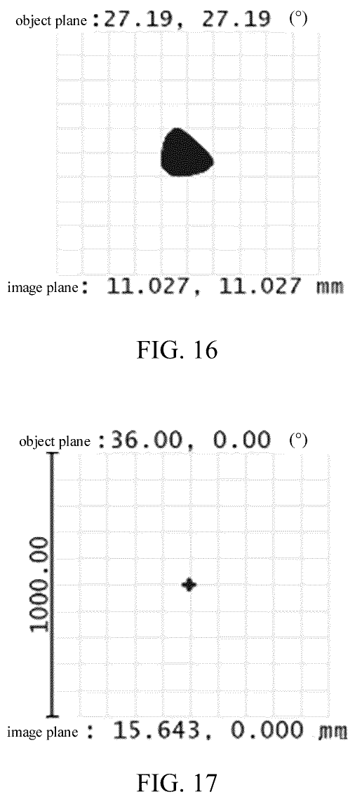

In the second comparative example, the surface of the lens away from the display screen 10 is a flat surface, the surface of the lens close to the display screen 10 is a spherical surface, a quarter-wave plate and a reflective polarizer are attached on the flat surface in a stacked manner, and a semi-transmissive and semi-reflective film is evaporated on the spherical surface. Results shown in FIGS. 14 to 16 are obtained after the simulation. FIG. 14 is a schematic diagram of the aberration in the tangential field of view in the second comparative example, FIG. 15 is a schematic diagram of the aberration in the sagittal field of view in the second comparative example, and FIG. 16 is a schematic diagram of the aberration in the other field of view in the second comparative example.

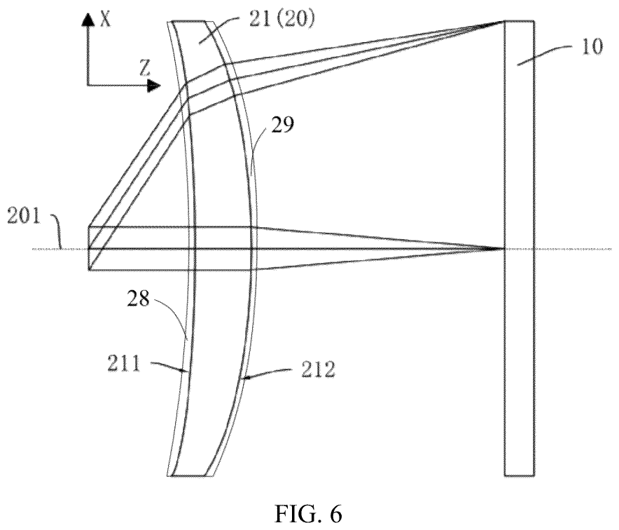

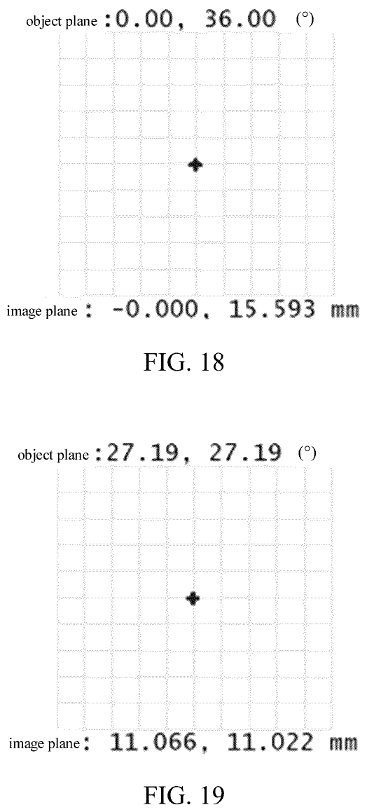

In the implemented example, the structure of the display module 100 shown in FIG. 5B or 6 is adopted, the first curved surface 211 is a cylindrical surface, the second curved surface 212 is a biconical surface, the first quarter-wave plate and the first reflective polarizer are attached on the first curved surface 211 in a stacked manner, and the first semi-transmissive and semi-reflective film is evaporated on the second curved surface 212. Results shown in FIGS. 17 to 19 are obtained after the simulation. FIG. 17 is a schematic diagram of the aberration in the tangential field of view in the implemented example, FIG. 18 is a schematic diagram of the aberration in the sagittal field of view in the implemented example, and FIG. 19 is a schematic diagram of the aberration in the other field of view in the implemented example.

It will be noted that, diameters of the lenses, the display screens and types of the films/plates are all the same in the above the first comparative example, the second comparative example and the implemented example, and the difference lies in the shape of the surface(s) of each lens.

It can be seen in FIGS. 11 to 19 that, in the first comparative example, the radius of the spot RMS is 143 microns in the tangential field of view, the radius of the spot RMS is 20 microns in the sagittal field of view, and the radius of the spot RMS is 98 microns in the other field of view; in the second comparative example, the radius of the spot RMS is 60 microns in each of the tangential field of view, the sagittal field of view and the other field of view; and in the implemented example, the radius of the spot RMS is 4 microns in each of the tangential field of view, the sagittal field of view and the other field of view. In the first comparative example, the radiuses of the spots are quite different in different fields of view, which will lead to blurred images and uneven display of the display module; in the second comparative example, the spots have the same dimension in different fields of view, but the dimension is relatively large, which results in blurred images, poor clarity, and low resolution of the display module; and in the implemented example, the spots have the same dimension in different fields of view, and the dimension is relatively small, which may effectively improve the imaging uniformity and clarity of the display module, and improve the display quality of the display apparatus 1000. Compared with the first comparative example, the biconical surface in the implemented example may correct the unconventional aberrations caused by the non-rotational symmetry of the cylindrical surface, thereby improving the imaging quality of the display module 100.

Referring to FIGS. 2, 3 and 20, the shape of the first lens 21 is designed in the embodiments of the present application to achieve the purpose of reducing the dimensions of the display module 100. In embodiments of the present application, special-shaped optical element 20 and special-shaped display screen 10 may be provided to further reduce the dimensions of the display module 100.

In embodiments of the present application, referring to FIGS. 2, 3 and 20, the special-shape-cutting may be performed on the optical element 20 to form the special-shaped display screen 10, so that a main optical axis 201 of the optical element 20 passes through the display screen 10 and is located at a side of a geometric center 101 of the display screen 10 close to the other display module 100.

Since the field of view at the temporal side is larger than the field of view at the nasal side of the human eye, the special-shape-cutting may be performed on the side of the optical element 20 close to the nasal side to reduce the dimensions of the optical element 20 in embodiments of the present application.

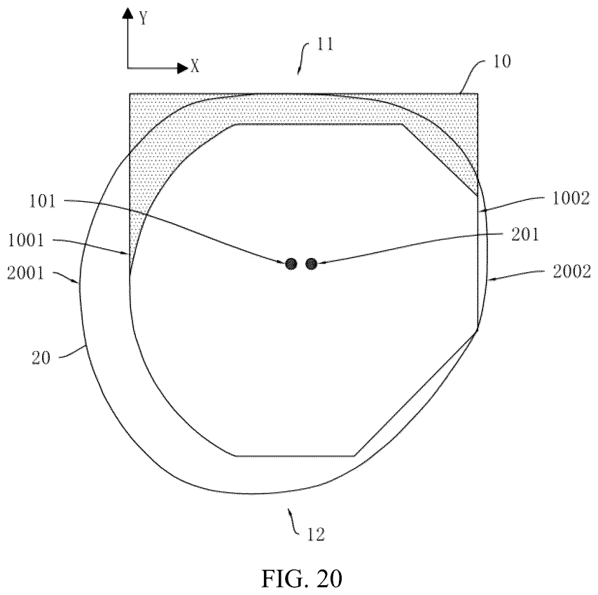

In an embodiment, as shown in FIG. 20, the optical element 20 includes a first profile edge 2001 and a second profile edge 2002 that are oppositely arranged along the first direction X, and the second profile edge 2002 is located between the first profile edge 2001 and the other display module 100. From a viewing angle perpendicular to the display screen 10, a minimum distance from the first profile edge 2001 to the main optical axis 201 is greater than a minimum distance from the second profile edge 2002 to the main optical axis 201.

In an embodiment, as shown in FIG. 20, the display screen 10 includes a third profile edge 1001 and a fourth profile edge 1002 that are oppositely arranged along the first direction X. The fourth profile edge 1002 is located between the third profile edge 1001 and the other display module 100. From the viewing angle perpendicular to the display screen 10, a minimum distance from the third profile edge 1001 to the main optical axis 201 is greater than a minimum distance from the fourth profile edge 1002 to the main optical axis 201.

In embodiments of the present application, the second profile edge 2002 of the optical element 20 is cut, such that the second profile edge 2002 is differentially arranged along the second direction Y.

As shown in FIG. 20, the display module 100 further includes a first side 11 and a second side 12 that are oppositely arranged along the second direction Y. A minimum distance from a portion of the second profile edge 2002 close to the first side 11 to the main optical axis 201 is greater than a minimum distance from a portion of the second profile edge 2002 close to the second side 12 to the main optical axis 201, and a minimum distance from a portion of the fourth profile edge 1002 close to the first side 11 to the main optical axis 201 is greater than a minimum distance from a portion of the fourth profile edge 1002 close to the second side 12 to the main optical axis 201. In practical use, the portion of the second profile edge 2002 close to the second side 12 in the optical element 20 is at a position close to the user's nose. Due to the obstruction of the nose, the minimum distance from the portion of the second profile edges 2002 close to the second side 12 to the main optical axis 201 is less than the minimum distance from other portion of the second profile edges 2002 to the main optical axis 201, which may further reduce the dimensions of the optical element 20.

Therefore, due to the difference in field of view between the temporal side and the nasal side of the human eye, the optical element 20 is cut to have a special shape in embodiments of the present application, which may further reduce the dimensions of the optical element 20 in conjunction with the special-shaped display screen 10, and thereby reduce the dimensions of the display module 100 and the display apparatus 1000.

In an embodiment, as shown in FIG. 20, the display screen 10 may be moved in a direction away from the other display module 100, so that the main optical axis 201 of the optical element 20 is located at the side of the geometric center 101 of the display screen 10 close to the other display module 100. The display screen 10 has a virtual intersection point that intersects the main optical axis 201, and a line connecting the virtual intersection point and the geometric center 101 of the display screen 10 is parallel to the first direction X.

In an embodiment, referring to FIGS. 3 and 20, an orthographic projection of the display screen 10 along the third direction Z is located within the orthographic projection of the optical element 20 along the third direction Z. That is, the display screen 10 is located in the optical element 20 from a viewing angle perpendicular to the display screen 10. Thus, all the light emitted from the display screen 10 may enter the optical element 20 to improve the imaging quality of the display module 100.

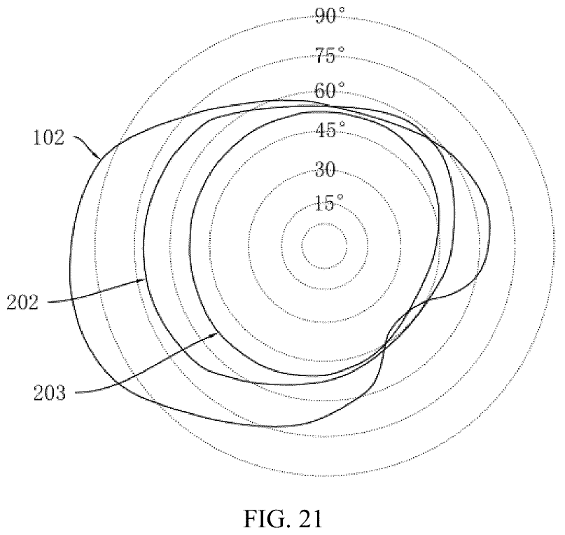

Referring to FIGS. 2, 3, 20, 21, 22 and 23, multiple fields of view are obtained by combining the optical elements 20 shaped by the special-shape-cutting and the special-shaped display screen 10 according to the embodiments of the present application.

The field of view 102 is the monocular field of view of the human eye (left eye), and the field of view 202, the field of view 203, the field of view 204, the field of view 205, and the field of view 206 are fields of view for optical elements 20 with different dimensions and distribution positions.

The optical element 20 in the field of view 202 has larger dimensions than the optical element 20 in the field of view 203, which is represented by the larger viewing angle of the field of view 202 in the first direction X.

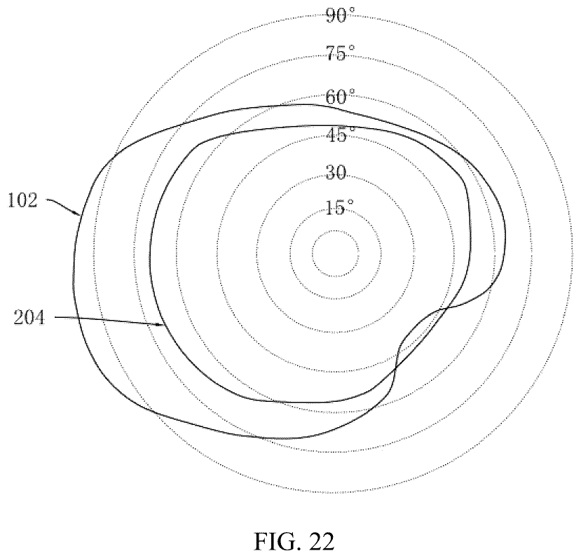

Compared with the field of view 202, the field of view 204 allows an increased viewing angle of the optical element 20 at the lower side in FIG. 22 and a decreased viewing angle at the upper side.

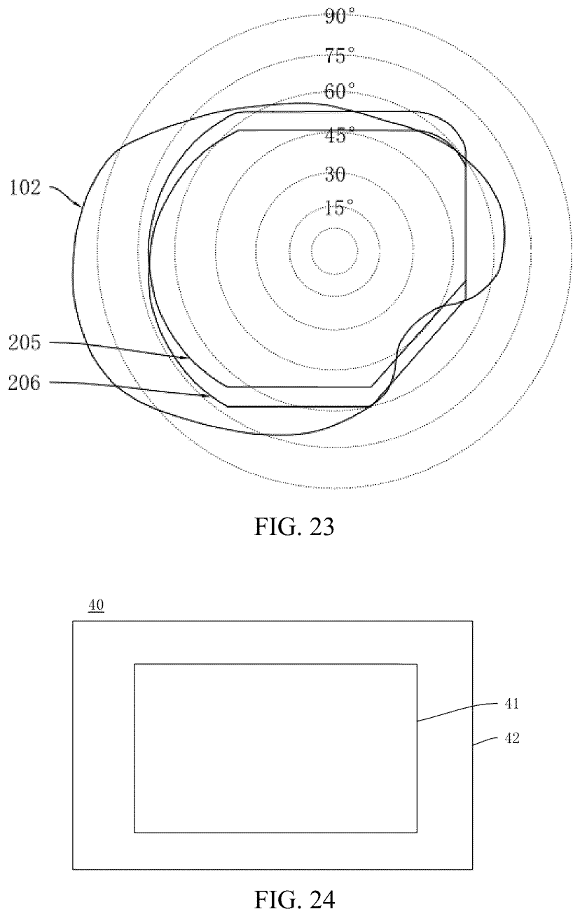

The field of view 205 allows a smaller viewing angle of the optical element 20 at the lower side in FIG. 23, and a larger viewing angle at the upper side, as compared with the field of view 206.

To sum up, in the embodiments of the present application, the first curved surface 211 of the first lens 21 in the optical element 20 at a side away from the display screen 10 is arranged to be a concave curved surface, and the first curved surface 211 is located on the first lens 21 at a side away from the display screen 10 (that is, the first curved surface 211 is located on a side close to the human eyes). Since the first curved surface 211 protrudes outward away from the human eyes, the dimensions of the first lens 21 in the direction parallel to the display screen 10 may be reduced. In addition, due to the difference in the field of view between the temporal side and the nasal side of the human eye, the optical element 20 is cut to have a special shape in embodiments of the present application, which may further reduce the dimensions of the optical element 20 in conjunction with the special-shaped display screen 10, and thereby reduce the dimensions of the display apparatus 1000. As a result, the convenience of use of the display apparatus 1000 is improved, and the adjustment function of the display apparatus 1000 for interpupillary distance is further facilitated.

Referring to FIG. 24, embodiment of the present application also provide an electronic device 40. The electronic device 40 includes a frame 42 and a display apparatus 41. The display apparatus 41 may be the display apparatus 1000 shown in FIG. 2 in the embodiments.

In an embodiment, the frame 42 may be used to secure and protect the display apparatus 41 described in the embodiments. In addition, the electronic device further includes a wearing apparatus, so that the electronic device can be worn on the user's face for virtual reality display.

It will be understood that since the electronic device includes the display apparatus described in the embodiments, the electronic device has the same beneficial effects as the display apparatus described in the embodiments, which will not be repeated herein.

In the embodiments, each embodiment is described with its own emphasis. For portions that are not described in detail in a certain embodiment, reference may be made to relevant descriptions of other embodiment(s).

The display apparatus and the electronic device provided in the embodiments of the present application are described in detail above. Specific examples are used herein to illustrate the principles and implementation methods of the present application. The description of the above embodiments is only used to help understand the technical solutions and core ideas thereof in the present application. Those of ordinary skill in the art should understand that they can still modify the technical solutions recorded in the embodiments, or make equivalent substitutions for some of the technical features. Thus, these modifications or substitutions shall fall within the scope of the present application.

What is claimed is:

1. A display apparatus, comprising:
one or more display screens; and
one or more optical elements corresponding to the one or more display screens respectively;
wherein for each optical element and its corresponding display screen, the optical element is disposed at a light exit side of the display screen, the optical element includes a first lens at a side away from the display screen, the first lens includes a first curved surface away from the display screen, and the first curved surface is a concave surface facing toward the display screen.

2. The display apparatus according to claim 1, wherein the first lens further comprises a second curved surface close to the display screen, and the second curved surface protrudes toward the display screen;
wherein the first curved surface is a cylindrical surface or a free-form surface, and the second curved surface is a cylindrical surface or a free-form surface.

3. The display apparatus according to claim 2, wherein the first curved surface is a cylindrical surface, and the optical element further comprises: a first reflective polarizer, a first quarter-wave plate, and a first semi-transmissive and semi-reflective film;
wherein the first quarter-wave plate is disposed on the first curved surface, and the first reflective polarizer is disposed on a side of the first quarter-wave plate away from the first curved surface, and the first semi-transmissive and semi-reflective film is located between the first quarter-wave plate and the display screen.

4. The display apparatus according to claim 3, wherein the second curved surface is a free-form surface, and the first semi-transmissive and semi-reflective film is disposed on the second curved surface.

5. The display apparatus according to claim 3, wherein the optical element further comprises a second lens disposed between the first lens and the display screen, the second lens comprises a third curved surface away from the display screen and a fourth curved surface close to the display screen, the second curved surface, the third curved surface and the fourth curved surface each are a free-form surface;
wherein the optical element further comprises a first anti-reflection film and a second anti-reflection film, and the first semi-transmissive and semi-reflective film is disposed on one of the second curved surface, the third curved surface and the fourth curved surface, and the first anti-reflection film and the second anti-reflection film are disposed on other two of the second curved surface, the third curved surface and the fourth curved surface, respectively.

6. The display apparatus according to claim 2, wherein the first curved surface is a free-form surface, and the second curved surface is a free-form surface; and
wherein the optical element further comprises a third anti-reflection film disposed on the first curved surface, and a fourth anti-reflection film disposed on the second curved surface.

7. The display apparatus according to claim 2, wherein the optical element further comprises a second lens disposed between the first lens and the display screen, the second lens comprises a third curved surface away from the display screen and a fourth curved surface close to the display screen, and the first curved surface and the fourth curved surface each are a free-form surface.

8. The display apparatus according to claim 7, wherein the second curved surface is a cylindrical surface, and the third curved surface is a free-form surface; and
the optical element further comprises: a second semi-transmissive and semi-reflective film, a fifth anti-reflective film, a sixth anti-reflective film, a second reflective polarizer disposed on the second curved surface, and a second quarter-wave plate disposed on a side of the second reflective polarizer away from the second curved surface, the fifth anti-reflection film is disposed on the first curved surface, the second semi-transmissive and semi-reflective film is disposed on one of the third curved surface and the fourth curved surface, and the sixth anti-reflection film is disposed on another one of the third curved surface and the fourth curved surface.

9. The display apparatus according to claim 7, wherein the third curved surface is a cylindrical surface, and the second curved surface is a free-form surface; and
the optical element further comprises: a third quarter-wave plate disposed on the third curved surface, a third reflective polarizer disposed on a side of the third quarter-wave plate away from the third curved surface, a third semi-transmissive and semi-reflective film disposed on the four-curved surface, a seventh anti-reflective film disposed on the first curved surface, and an eighth anti-reflective film disposed on the second curved surface.

10. The display apparatus according to claim 2, wherein the display apparatus comprises two display modules that are arranged side by side along a first direction, and each of the display modules comprises one said optical element and its corresponding display screen;
wherein the cylindrical surface in each of the optical elements is curved in the first direction.

11. The display apparatus according to claim 2, wherein at least one of the first curved surface and the second curved surface is a cylindrical surface with a curvature radius greater than or equal to 100 mm, and less than or equal to 2000 mm.

12. The display apparatus according to claim 1, wherein the display apparatus comprises two display modules that are arranged side by side along a first direction, and each of the display modules comprises one said optical element and its corresponding display screen;
in each of the display modules:
a main optical axis of the optical element passes through the display screen and is located at a side of a geometric center of the display screen close to the other of the display modules; and
the optical element comprises a first profile edge and a second profile edge that are oppositely arranged along the first direction, and the second profile edge is located between the first profile edge and the other of the display modules;
wherein from a viewing angle perpendicular to the display screen, a minimum distance from the first profile edge to the main optical axis is greater than a minimum distance from the second profile edge to the main optical axis.

13. The display apparatus according to claim 12, wherein in each of the display modules, the display screen comprises a third profile edge and a fourth profile edge that are oppositely arranged along the first direction, the fourth profile edge is located between the third profile edge and the other of the display modules;
wherein from the viewing angle perpendicular to the display screen, a minimum distance from the third profile edge to the main optical axis is greater than a minimum distance from the fourth profile edge to the main optical axis.

14. The display apparatus according to claim 13, wherein each of the display modules further comprises a first side and a second side that are oppositely arranged along a second direction, the second direction being perpendicular to the first direction and parallel to the display screen of the display module;
in each of the display modules:
a minimum distance from a portion of the second profile edge close to the first side to the main optical axis is greater than a minimum distance from a portion of the second profile edge close to the second side to the main optical axis; and
a minimum distance from a portion of the fourth profile edge close to the first side to the main optical axis is greater than a minimum distance from a portion of the fourth profile edge close to the second side to the main optical axis.

15. The display apparatus according to claim 12, wherein in each of the display modules, the display screen has a virtual intersection point intersecting the main optical axis, and a line connecting the virtual intersection point and the geometric center of the display screen is parallel to the first direction.

16. The display apparatus of claim 1, wherein the display screen is located in the optical element from a viewing angle perpendicular to the display screen.

17. An electronic device, comprising a frame and a display apparatus;
wherein the display apparatus comprises:
one or more display screens; and
one or more optical elements corresponding to the one or more display screens respectively;
wherein for each optical element and its corresponding display screen, the optical element is disposed at a light exit side of the display screen, the optical element includes a first lens at a side away from the display screen, the first lens includes a first curved surface away from the display screen, and the first curved surface is a concave surface facing toward the display screen.

18. The electronic device according to claim 17, wherein the first lens further comprises a second curved surface close to the display screen, and the second curved surface protrudes toward the display screen;
wherein the first curved surface is a cylindrical surface or a free-form surface, and the second curved surface is a cylindrical surface or a free-form surface.

19. The electronic device according to claim 18, wherein the first curved surface is the cylindrical surface, and the optical element further comprises: a first reflective polarizer, a first quarter-wave plate, and a first semi-transmissive and semi-reflective film;
wherein the first quarter-wave plate is disposed on the first curved surface, and the first reflective polarizer is disposed on a side of the first quarter-wave plate away from the first curved surface, and the first semi-transmissive and semi-reflective film is located between the first quarter-wave plate and the display screen.

20. The electronic device according to claim 17, wherein the display apparatus comprises two display modules that are arranged side by side along a first direction, and each of the display modules comprises one said optical element and its corresponding display screen;
in each of the display modules:
a main optical axis of the optical element passes through the display screen and is located at a side of a geometric center of the display screen close to the other of the display modules; and
the optical element comprises a first profile edge and a second profile edge that are oppositely arranged along the first direction, and the second profile edge is located between the first profile edge and the other of the display modules;
wherein from a viewing angle perpendicular to the display screen, a minimum distance from the first profile edge to the main optical axis is greater than a minimum distance from the second profile edge to the main optical axis.
